(19) United States
(12) Patent Application Publication
(10) Pub. No.: US 2003/0040848 A1
(43) Pub. Date: Feb. 27, 2003

(54) Virtual reality into fortran plus matrix

(76) Inventor: George Anthony Guarracino, Boston, MA (US)

Correspondence Address: George Guarracino, 33 Blossom St, Boston, MA, 02114, US

(21) Appl. No.: 09/878,790

(22) Filed: Aug. 15, 2001

Related U.S. Application Data
(60) Provisional application No. 60/128,908, filed on Apr. 12, 1999.

(51) Int. Cl. G05D 23/00

(52) U.S. Cl. 700/299

(57) ABSTRACT

The invention is and can be a security system for homes, Businesses, area's and individuals. That would be able to anticipate a problem before it developed. Using past information and current information.

1a] virtual reality is described as any item that can be picked out of real life.

2a] a matrix is described as as holding tha t item or [thing] as to where it would be on a map.

3a] programming is described a the vechile that would move that item or [thing] within the matrix.

### BACKGROUND OF THE INVENTION

The invention is a hybreed of technologies that exist

That used in this configuration will produce a configuration That will in advance recognize a problem.

### FIELD OF ENDEVOR

AS mentioned before the invention, field of endevor is, A security system tha t would be applicable to in decendeing Order personell, buildings, and areas, that would anticipat a problem Before it happened.

### DETAILED DESCRIPTION OF THE INVENTION

The invention is neveau thinking tthat came to light, in June of 1999; In incoperates many technologies that are on the market but never Used in this way, it can mirror and or dirict an f14 fantom jet on its Way and pin point a problem before it starts, and is usable to Areas, personell and buildings thus allowing an item to be in a matrix Putting it thu aseries a of situatuions while the subject is on screen In what is called virtual reality.

### BREIF SUMMARY OF THE INVENTION

The invention a security system that will anticipate a Problem before it transpires

What I claim is my invention:

1a] Will create a situation and use a situation in which an outcome will be created.

2a] To continue, to have an item in virtual reality and a n opposing matrix to a point where they would realize an action should be taken.

3a] the system would be usable in buildings where it could maintain the buildings systems and report a failure in fire detiction, heating and cooling, also also restricted area's. This would also include personell on several levels.
1] communications
a] phone
b] e mail
